(19) United States
(12) Patent Application Publication
(10) Pub. No.: US 2004/0073639 A1
(43) Pub. Date: Apr. 15, 2004

(54) Method of load balancing across two or more servers in a computer network

(76) Inventors: Tony Basoglu, Hong Kong (HK); Yusuf Goolamabbas, Hong Kong (HK); Raymond Wai Man Lee, Hong Kong (HK)

Correspondence Address: JACKSON WALKER L.L.P., Suite 2100, 112 E. Pecan Street, San Antonio, TX, 78205, US

(21) Appl. No.: 10/236,131

(22) Filed: Sep. 6, 2002

(51) Int. Cl. G06F 15/173

(52) U.S. Cl. 709/223; 709/224

(57) ABSTRACT

A method of load balancing across two or more servers in a computer network includes determining the load on each server and formulating which, if any, groups of data stored on a server can be migrated between the file servers to balance the interaction load across them.

### BACKGROUND TO THE INVENTION

1. Field of the Invention

The invention relates to computer systems. In particular the invention relates to methods of load balancing across two or more servers in a computer network.

2. Background Information

Large computer networks with many clients often have several identical servers all capable of performing the same operation. So that one server is not performing at or near its maximum capability while others are under-utilised loader balancing methods are known which attempt to balance interactions amongst the clients and servers.

One problem with these known methods is that they do not address the situation were only one particular server is capable of performing a particular operation, i.e. the servers are not identical. This situation is present, for example, were a large number of individual “user accounts” are distributed across several servers in a network.

### SUMMARY OF THE INVENTION

It is an object of the present invention to provide a method of balancing server interactions that overcomes or at least ameliorates the above problem, or at least provides the public with a useful alternative. According to a first aspect of the invention there is provided a method of balancing server interactions across two or more servers in a network including; monitoring one or more types of server interaction across two or more servers and storing interaction data, and at one or more predetermined times; analysing the interaction data to obtain an interaction score for each of the two or more servers, comparing the interaction score for each of the two or more servers to interaction criteria and identifying any irregular servers in the two or more servers, identifying one or more groups of data, if any, to be moved to or from the irregular servers to balance the server interactions, and moving said groups of data.

According to a second aspect of the invention there is provided a method of balancing server interactions across two or more servers in a network, wherein interaction data relating to server interactions is recorded in one or more log files, the method including at one or more predetermined times; analysing interaction data from one or more log files to obtain an interaction score for two or more servers in a network, comparing the interaction score for each of the two or more servers to interaction criteria and identifying any irregular servers in the two or more servers, identifying one or more groups of data, if any, to be moved to or from the irregular servers to balance the server interactions, and moving said groups of data. Preferably, the method also includes consolidating the one or more log files prior to analysing the interaction data.

Preferably, the interaction data includes the type of the server interaction and which of the two or more servers was involved in the interaction.

Preferably, the interaction data includes the type of the server interaction, and wherein analyzing the interaction data includes assigning a weighting factor to the one or more types of server interaction and determining a sum of the weighting factors for the server interactions associated with each of the two or more servers, and wherein the interaction score is the sum.

Preferably, the interaction criteria are a first preferred interaction score and a second preferred interaction score, the one or more irregular servers being one or more servers where the interaction score is below the first preferred interaction score or above the second preferred interaction score, and wherein the one or more groups of data are moved from the irregular servers having the interaction score above the second preferred interaction score to the irregular servers having the interaction score below the first preferred interaction score.

Preferably, the first preferred interaction score and the second preferred interaction score are dynamically determined using an average of the interaction scores of all of the two or more servers.

Preferably, the one or more groups of data are temporarily moved to a temporary storage location.

According to a third aspect of the invention there is provided a method of balancing server interactions across two or more file servers in a computer network, wherein the two or more file servers store information relating to a plurality of users, and wherein interaction data relating to server interactions is recorded in one or more log files, the method including at one or more predetermined times: analysing interaction data from one or more log files to obtain an interaction score for two or more servers in a network, manipulating the interaction scores for the two or more servers to identify any irregular servers in the two or more servers, identifying information relating to one or more users to be moved to or from the irregular servers to balance the server interactions, and moving the information relating to one or more users.

Preferably, the method also includes consolidating the one or more log files prior to analysing the interaction data.

Preferably, the interaction data includes the type of the server interaction, and wherein analysing the interaction data includes assigning a weighting factor to the one or more types of server interaction and determining a sum of the weighting factors for the server interactions associated with each of the two or more servers, and wherein the interaction score is the sum.

Preferably, the interaction scores for the two or more servers includes determining an average interaction score and determining relative deviations of the interaction scores from the average interaction score, the irregular servers having relative deviation below a first reference deviation or above a second relative deviation.

Preferably, the first reference deviation is a predefined range below the average interaction score and the second relative deviation is a predetermined range above the average interaction score.

Preferably, the steps are repeated at the one or more predetermined times.

According to a forth aspect of the invention there is provided a computer readable medium including instructions to one or more computers for performing steps to balance is server interactions across two or more file servers in a network, wherein interaction data relating to server interactions is recorded in one or more log files, the steps including at one or more predetermined times: analysing interaction data from one or more log files to obtain an interaction score for two or more servers in a network, comparing the interaction score for each of the two or more servers to interaction criteria and identifying any irregular servers in the two or more servers, identifying one or more groups of data, if any, to be moved to or from the irregular servers to balance the server interactions, and moving said groups of data,

Preferably, the steps include consolidating the one or more log files prior to analyzing the interaction data.

Preferably, the interaction data includes the type of the server interaction and which of the two or more servers was involved in the interaction.

Preferably, the interaction data includes the type of the server interaction, and wherein analyzing the interaction data includes assigning a weighting factor to the one or more types of server interaction and determining a sum of the weighting factors for the server interactions associated with each of the two or more servers, and wherein the interaction score is the sum.

Preferably, the interaction criteria are a first preferred interaction score and a second preferred interaction score, the one or more irregular servers being one or more servers where the interaction score is below the first preferred interaction score or above the second preferred interaction score, and wherein the one or more groups of data are moved from the irregular servers having the interaction score above the second preferred interaction score to the irregular servers having the interaction score below the first preferred interaction score.

Preferably, the first preferred interaction score and the second preferred interaction score are dynamically determined using an average of the interaction scores of all of the two or more servers.

Preferably, the one or more groups of data are temporarily moved to a temporary storage location.

Further aspects of the invention will become apparent from the following description, which is given by way of example is only.

### BRIEF DESCRIPTION OF THE DRAWINGS

Embodiments of the invention will now be described with reference to the accompanying drawings in which.

FIG. 1 illustrates a schematic overview of a load balancing system according to the invention.

FIG. 2 illustrates a flow diagram of the steps in the load balancing system.

### DESCRIPTION OF THE PREFERRED EMBODIMENTS

The invention will now be described by way of example and with reference to a system for load balancing across a network of file servers containing user account information, including disk storage and e-mail ‘mailboxes’, such as might be used by a large company or Internet Service Provider (ISP). However, the invention also finds use and other situations were it is desirable to load balance computer or server interactions across two or more servers in a computer network

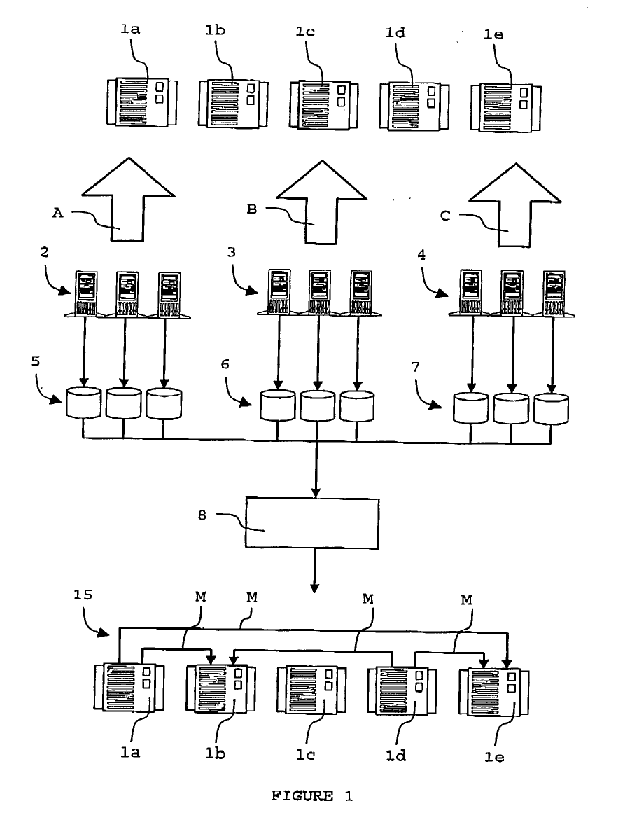

Referring to FIG. 1, a network includes, amongst other things, a plurality of File Servers 1a, 1b, 1c, 1d, 1e (collectively referred to by numeral 1) containing user accounts, and clusters of Web servers 2, Mail servers 3 and Internet Mail Application Protocol (IMAP) servers 4.

The Web Servers 2, Mail Servers 3 and IMAP Servers 4 all run processes that interact with the File Servers, placing varying degrees of load upon the file servers 1. Processes run by the web, mail and IMAP servers 2, 3, 4 include, amongst others, ‘imapd’, ‘redirect ’ and ‘dud’. For example, Web Servers 2 run ‘imapd’, Mail Servers 3 run ‘redirect ’ and IMAP Servers 4 run both ‘imapd ’ and ‘dud’. Each process places a different load on the file server 1 to which it is directed. Typically, each Web Server 2, Mail Server 3 and IMAP Server 4 records its interactivity with the File Servers 1 in its own log file 5, 6, 7.

Due to user account activity some file servers, for example 1a and 1d, experience a higher than average loading while other file servers, for example 1b and 1e, experience a lower than average loading.

To balance this load, a Load-balance program 8 is run at regular time intervals. The Load-balance program 8 determines the load on each server 1 and formulates which, if any, user accounts to migrate between file servers 1 to balance the interaction load across them. In FIG. 1 the migration of user accounts is represented by arrows M from servers 1a and 1d with a higher than average loading to file servers 1b and 1e with a lower than average loading. In the preferred embodiment the load-balancing programme 8 is run every 24 hours. In alternative embodiments the load-balancing programme 8 is run periodically at any convenient period during low network usage times.

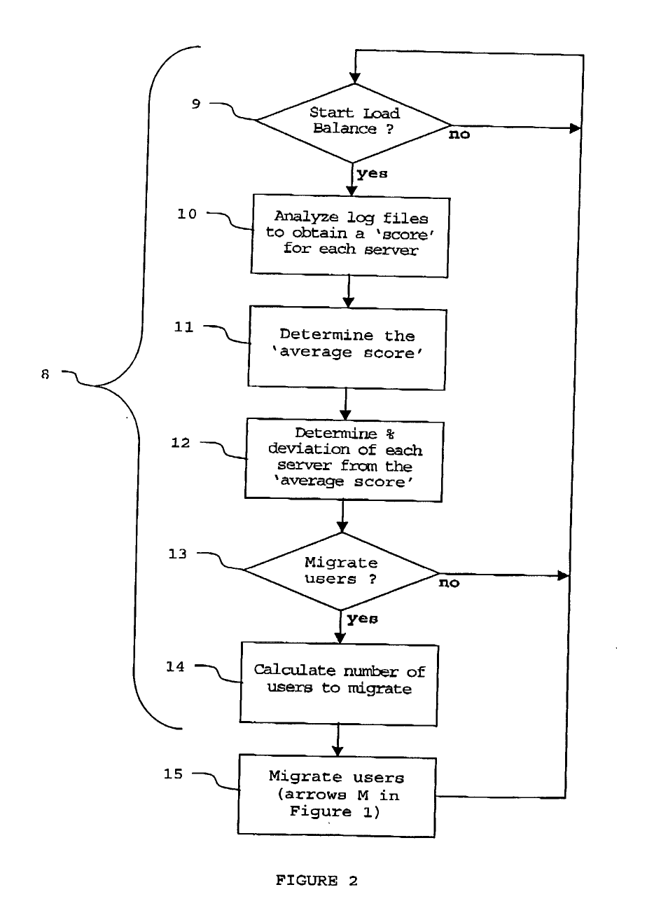

FIG. 2 illustrates a flow diagram of the process steps of the load-balancing programme 8. In the first step 8 the process waits for the predetermined time at which the load-balancing programme 8 is to run In the preferred example this is 2 am each day.

When the predetermined run time is reached the load-balancing program 8 reads each log file 5, 6, 7 to analyse all server interactions. A weighting value is applied to different types of interaction and the weighting values for interactions are summed for each server 1a, 1b, 1c, 1d, 1e to establish a weighted load ‘score’ for each server 1a, 1b, 1c, 1d, 1e.

For example, the weighting values for each of the above mentioned process interactions might be:

‘imapd’ interactions=5

‘redirect’ interactions=3

‘dud’ interactions=2

If I is the number of ‘imapd’ interactions with file server 1a, R is the number of ‘redirect’ interactions with server 1a, and U is the number of ‘dud’ interactions with server 1a then the weighting score W for server 1a is given by:

W=(I×5)+(R×3)+(D×2)

The weighting scores of each File Server 1a, 1b, 1c, 1d, 1e are manipulated to identify those File Servers 1 whose score is outside certain interaction criteria. In the preferred example interaction criteria are upper and lower threshold values. The determination is made based upon deviation of a given File Server's weighted score from the average weighted score of all the File Servers. Thus the next step 11 in the preferred example is to calculate the average weighted score. The average weighted score (AS) is the sum of the weighting scores (W) of all file servers 1a, is 1b, 1c, 1d, 1e divided by the number of file servers 1. The formula is:

$$A S = \frac{( {W}_{1 a} + {W}_{1 b} + {W}_{1 c} + {W}_{1 d} + {W}_{1 e} )}{5}$$

The average loading, and thus the average weighted score, of the file servers 1 is dynamic with the number and size of user accounts. This will vary as a company or ISP grows. To overcome this problem the next step 12 in the process of the preferred example is to determine a relative or percentage deviation for the score of each file server 1a, 1b, 1c, 1d, 1e from the average weighted score. The percentage deviation (L) for each file server 1a, 1b, 1c, 1d, 1e is given by:

$${L}_{1 x} = \frac{{W}_{1 x} - A S}{A S} \times 100$$

Where L_{1X} is the percentage deviation (L) for a file server X, W_{1X} is the weighting scores (W) of the File Server X, and AS is the average weighted score.

A File Server is considered to be irregular if its percentage deviation (L) is below a first predefined threshold percentage or above a second predefined threshold percentage. In the preferred embodiment the first and second predefined threshold percentages are −5% and +5% of the average weighted score. The first and second is predefined threshold percentages are definable by a network administrator/user in an options field via the load-balancing program's graphical user interface (GUI).

Once any irregular file servers are identified a decision 13 is made as to whether users are to be moved (migrated) between file servers 1 to balance the load. In the preferred example users are only migrated if there is at least one irregular file server below the first predefined threshold percentage and at least one irregular tile server above the second predefined threshold percentage. User accounts are migrated from any irregular file servers above the second predefined threshold percentage, in this example files servers 1a and 1d, to the irregular file servers below the first predefined threshold percentage, in this example file servers 1b and 1e.

In other embodiments user accounts, or files generally, are migrated to and from both irregular and “normal’, servers to balance the interaction load.

If no user accounts are to migrate then load-balancing program terminates and waits for the next predefined period at which to run. If user accounts are to be migrated then the next step 14 in the process is to determine how many user accounts to migrate from irregular file servers 1a and 1d to irregular file servers 1b and 1e. Only active user accounts are migrated as inactive accounts have no effect on interaction loading, In the preferred example active accounts are those that have been used in the last 30 days. The number of active user accounts to migrate to or from each File Server is calculated as follows.

Firstly, the average number of active user accounts (U) on the file servers involved in the migration is calculated. In the present example the file servers involved in the migration are 1a, 1b, 1d , 1e. The formula is:

$$U = \frac{( {U}_{1 a} + {U}_{1 b} + {U}_{1 d} + {U}_{1 e} )}{4}$$

where U1a, U1b, U1d, and U1e are the number of active users on each file server.

Secondly, the Percentage (P) of active user accounts to be migrated is calculated according to the following formula:

$$P = \frac{A B S ( {L}_{1} ) + A B S ( {L}_{2} ) + … + A B S ( {L}_{m} )}{2}$$

Where AnS(Lm) is the absolute value of Lm.

Thirdly, the number of active users (M) to migrate to or is from each file server 1a, 1b, 1d,1e involved in the migration is determined according to the following formula:

$${M}_{1 x} = \frac{U \times P \times {L}_{1 x}}{\begin{matrix}{L}_{1 a} + {L}_{1 b} + {L}_{1 d} + {L}_{1 e} \\ ( sum of L of each involved server )\end{matrix}} \times 100$$

Where M_{1X} is the number of user accounts to migrate to or from File Server X, U is the average number of active user accounts, P is the Percentage of active user accounts, and L_{1X}. is the percentage deviation of File Server X.

For each File Server X involved in the migration, the corresponding number of active user accounts Mix is either migrated in or migrated out, depending upon whether they are below or above the first or second predefined threshold percentages respectively.

The final step 15 in the process is to migrate user accounts out of all file servers, as required, to a temporary location. Once all migrations out are complete the user accounts are migrated from the temporary location in to file servers, as required. The source and destination file servers for individual migrated user account is immaterial. The total number of user accounts to be migrated in matches the total number of user accounts migrated out.

Once the migration of user accounts is complete the load-balancing program 8 terminates The process is repeated at the next predetermined time (every 24 hours). The invention ensures that File Server resources are always utilised in the most efficient manner possible.

The preferred example relates to the storage of user account information. In alternative embodiments the file servers 1 may be any computers storing data, information or executable tiles and web servers 2, mail servers 3 and IMAP servers 4 may be any servers or process that access said data, information or executable files or interact in other ways with said computers.

In the preferred example the and web servers 2, mail servers 3 and IMAP servers 4 create log files of their interactions with file servers 1. In alternative embodiments the invention may include monitoring interactions with servers and creating one or more log files, for example each server may run a process that is records interactions with it in a log file. Furthermore, the alternative embodiments consolidate the one or more log files into a master log file prior to analysing the interactions.

In the preferred example the process only migrates user accounts between irregular servers. In alternative embodiments the migration is across all servers. For example if there are only irregular servers below the first predefined threshold then user accounts are migrated from normal servers to the irregular servers to balance the load. If there are only irregular servers above the second predefined threshold then user accounts are migrated to normal servers from the irregular servers to balance the load.

In the preferred example the determination of irregular servers is dynamically based on a percentage deviation from an average load across all servers. In alternative embodiments it is based on absolute values. For example the first and second predefined threshold values are absolute score values and any server with a weighting score outside first and second threshold values is an irregular server.

Where in the foregoing description reference has been made to integers or elements having known equivalents then such are included as if individually set forth herein.

Embodiments of the invention have been described, however it is understood that variations, improvement or modifications can take place without departure from the spirit of the invention or scope of the appended claims.

What is claimed is:

1. A method of balancing server interactions across two or more servers in a network including:
monitoring one or more types of server interaction across two or more servers and storing interaction data, and at one or more predetermined times:
analysing the interaction data to obtain an interaction score for each of the two or more servers,
comparing the interaction score for each of the two or more servers to interaction criteria and identifying any irregular servers in the two or more servers,
identifying one or more groups of data, if any, to be moved to or from the irregular servers to balance the server interactions, and
moving said groups of data.

2. A method as claimed in claim 1 wherein the interaction data includes the type of the server interaction and which of the two or more servers was involved in the interaction.

3. A method as claimed in claim 1 wherein the interaction data includes the type of the server interaction, and wherein analysing the interaction data includes assigning a weighting factor to the one or more types of server interaction and determining a sum of the weighting factors for the server interactions associated with each of the two or more servers, and wherein the interaction score is the SUM.

4. A method as claimed in claim 1 wherein interaction criteria are a first preferred interaction score and a second preferred interaction score, the one or more irregular servers being one or more servers where the interaction score is below the first preferred interaction score or above the second preferred interaction score, and wherein the one or more groups of data are moved from the irregular servers having the interaction score above the second preferred interaction score to the irregular servers having the interaction score below the first preferred interaction score.

5. A method as claimed in claim 4 wherein the first preferred interaction score and the second preferred interaction score are dynamically determined using an average of the interaction scores of all of the two or more servers.

6. A method as claimed in claim 1 wherein the one or more groups of data are temporarily moved to a temporary storage location,

7. A method of balancing server interactions across two or more servers in a network, wherein interaction data relating to server interactions is recorded in one or more log files, the method including at one or more predetermined times:
analysing interaction data from one or more log files to obtain an interaction score for two or more servers in a network,
comparing the interaction score for each of the two or more servers to interaction criteria and is identifying any irregular servers in the two or more servers,
identifying one or more groups of data, if any, to be moved to or from the irregular servers to balance the server interactions, and
moving said groups of data.

8. A method as claimed in claim 7 including consolidating the one or more log files prior to analysing the interaction data.

9. A method as claimed in claim 7 wherein the interaction data includes the type of the server interaction and which of the two or more servers was involved in the interaction.

10. A method as claimed in claim 7 wherein the interaction data includes the type of the server interaction, and wherein analysing the interaction data includes assigning a weighting factor to the one or more types of server interaction and determining a sum of the weighting factors for the server interactions associated with each of the two or more servers, and wherein the interaction score is the sum.

11. A method as claimed in claim 7 wherein interaction is criteria are a first preferred interaction score and a second preferred interaction score, the one or more irregular servers being one or more servers where the interaction score is below the first preferred interaction score or above the second preferred interaction score, and wherein the one or more groups of data are moved from the irregular servers having the interaction score above the second preferred interaction score to the irregular servers having the interaction score below the first preferred interaction score.

12. A method as claimed in claim 11 wherein the first preferred interaction score and the second preferred interaction score are dynamically determined using an average of the interaction scores of all of the two or more servers.

13. A method as claimed in claim 7 wherein the one or more groups of data are temporarily moved to a temporary storage location.

14. A method of balancing server interactions across two or more file servers in a computer network, wherein the two or more file servers store information relating to a plurality of users, and wherein interaction data relating to server interactions is recorded in one or more log files, the method including at one or more predetermined times:
analysing interaction data from one or more log files to obtain an interaction score for two or more servers in a network,
manipulating the interaction scores for the two or more servers to identify any irregular servers in the two or more servers,
identifying information relating to one or more users to be moved to or from the irregular servers to balance the server interactions, and
moving the information relating to one or more users.

15. A method as claimed in claim 14 including consolidating the one or more log files prior to analysing the interaction data.

16. A method as claimed in claim 14 wherein the interaction data includes the type of the server interaction, and wherein analysing the interaction data includes assigning a weighting factor to the one or more types of server Interaction and determining a sum of the weighting factors for the server interactions associated with each of the two or more servers, and wherein the interaction score is the sum.

17. A method as claimed in claim 14 wherein manipulating the interaction scores for the two or more servers includes determining an average interaction score and determining relative deviations of the interaction scores from the average interaction score, the irregular servers having relative deviation below a first reference deviation or above a second relative deviation.

18. A method as claimed in claim 17 wherein the first reference deviation is a predefined range below the average interaction score and the second relative deviation is a predetermined range above the average interaction score.

19. A method as claimed in claim 14 wherein the steps are repeated at the one or more predetermined times.

20. A computer readable medium including instructions to one or more computers for performing steps to balance server interactions across two or more file servers in a network, wherein interaction data relating to server interactions is recorded in one or more log files, the steps including at one or more predetermined times:
analysing interaction data from one or more log files to obtain an interaction score for two or more servers in a network,
comparing the interaction score for each of the two or more servers to interaction criteria and identifying any irregular servers in the two or more servers,
identifying one or more groups of data, if any, to be moved to or from the irregular servers to balance the server interactions, and
moving said groups of data.

21. A computer readable medium as claimed in claim 20 wherein the steps include consolidating the one or more log files prior to analysing the interaction data.

22. A computer readable medium as claimed in claim 20 wherein the interaction data includes the type of the server interaction and which of the two or more servers was involved in the interaction.

23. A computer readable medium as claimed in claim 20 wherein the interaction data includes the type of the server interaction, and wherein analysing the interaction data includes assigning a weighting factor to the one or more types of server interaction and determining a sum of the weighting factors for the server interactions associated with each of the two or more servers, and wherein the interaction score is the sum.

24. A computer readable medium as claimed in claim 20 wherein interaction criteria are a first preferred interaction score and a second preferred interaction score, the one or more irregular servers being one or more servers where the interaction score is below the first preferred interaction score or above the second preferred interaction score, and wherein the one or more groups of data are moved from the irregular servers having the interaction score above the second preferred interaction score to the irregular servers having the interaction score below the first preferred interaction score.

25. A computer readable medium as claimed in claim 24 wherein the first preferred interaction score and the second preferred interaction score are dynamically determined using an average of the interaction scores of is all of the two or more servers.

26. A computer readable medium as claimed in claim 20 wherein the one or more groups of data are temporarily moved to a temporary storage location.
